(19) United States
(12) Patent Application Publication
(10) Pub. No.: US 2014/0282250 A1
(43) Pub. Date: Sep. 18, 2014

(54) MENU INTERFACE WITH SCROLLABLE ARRANGEMENTS OF SELECTABLE ELEMENTS

(71) Applicants: Daniel E. Riddell, Oakland, CA (US); Guido Rosso, Palo Alto, CA (US); Fabian Birgfeld, London (GB); Michael Albers, London (GB)

(72) Inventors: Daniel E. Riddell, Oakland, CA (US); Guido Rosso, Palo Alto, CA (US); Fabian Birgfeld, London (GB); Michael Albers, London (GB)

(21) Appl. No.: 13/829,709

(22) Filed: Mar. 14, 2013

(51) Int. Cl. G06F 3/0485

(52) U.S. Cl. CPC G06F 3/0485
USPC 715/830

(57) ABSTRACT

In embodiments, apparatuses, methods and storage media are described that are associated with menu interfaces for media source and content navigation. In embodiments, a menu interface may be selectively rendered. In various embodiments, the selective rendering may include selectively rendering a first scrollable arrangement of selectable elements disposed along a first axis to represent sources of media content; and selectively rendering a second scrollable arrangement of selectable elements to represent media contents available from only a selected one of the sources of media content and not unselected ones of the sources of media content, wherein the second scrollable arrangement of selectable elements is disposed along a second axis that extends from the first axis.

### TECHNICAL FIELD

The present disclosure relates to the field of data processing, in particular, to apparatuses, methods and storage media associated with menu interfaces with scrollable arrangements of selectable elements.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of media content, and the manners in which the content is consumed. Today, myriad media content may be made available from various sources of media content, including but not limited to fixed medium (e.g., Digital Versatile Disk (DVD)), broadcast, cable operators, satellite channels, Internet, and so forth. Users may consume content with a television set, a laptop or desktop computer, a tablet, a smartphone, or other devices of the like. In some cases, navigating through large numbers of media content, and/or through heterogeneous sources of media content, which may be distributed among disparate graphical user interfaces and/or menus, may be cumbersome, in particular, using the typical prior art grid or table listing of programming names.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an arrangement for content distribution and consumption, in accordance with various embodiments.

FIG. 2 illustrates an example player configured with applicable portions of the present disclosure and causing a television to present a media content, in accordance with various embodiments.

FIGS. 3 and 4 illustrate the player of FIG. 2 causing the television to render a first scrollable arrangement of selectable elements that form part of a menu interface overlaying the media content, in accordance with various embodiments.

FIGS. 5 and 6 illustrates the player of FIGS. 2-4 causing the television to render a second scrollable arrangement of selectable elements that form part of the menu interface overlaying the media content, in accordance with various embodiments.

FIG. 7 illustrates an example scenario in which users are identified, and a menu interface is rendered based at least in part on identified users' preferences, in accordance with various embodiments.

FIG. 8 depicts an example process that may be implemented on various computing devices described herein, in accordance with various embodiments.

FIG. 9 illustrates an example computing environment suitable for practicing various aspects of the disclosure, in accordance with various embodiments.

FIG. 10 illustrates an example storage medium with instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Referring now to FIG. 1, an arrangement for content distribution and consumption, in accordance with various embodiments, is illustrated. As shown, in embodiments, arrangement 100 for distribution and consumption of content may include a number of content consumption devices 108 coupled with one or more content aggregator/distributor servers 104 via one or more networks 106. Content aggregator/distributor servers 104 may be configured to aggregate and distribute content to content consumption devices 108 for consumption, via one or more networks 106.

In embodiments, as shown, content aggregator/distributor servers 104 may include encoder 112, storage 114 and content provisioning 116 (referred to as “streaming engine” in FIG. 1), which may be coupled to each other as shown. Encoder 112 may be configured to encode content 102 from various content providers, and storage 114 may be configured to store encoded content. Content provisioning 116 may be configured to selectively retrieve and provide encoded content to the various content consumption devices 108 in response to requests from the various content consumption devices 108. Content 102 may be media content of various types, having video, audio, and/or closed captions, from a variety of content creators and/or providers. Examples of content may include, but are not limited to, movies, TV programming, user created content (such as YouTube video, iReporter video), music albums/titles/pieces, and so forth. Examples of content creators and/or providers may include, but are not limited to, movie studios/distributors, television programmers, television broadcasters, satellite programming broadcasters, cable operators, online users, and so forth.

In various embodiments, for efficiency of operation, encoder 112 may be configured to encode the various content 102, typically in different encoding formats, into a subset of one or more common encoding formats. However, encoder 112 may be configured to nonetheless maintain indices or cross-references to the corresponding content in their original encoding formats. Similarly, for flexibility of operation, encoder 112 may encode or otherwise process each or selected ones of content 102 into multiple versions of different quality levels. The different versions may provide different resolutions, different bitrates, and/or different frame rates for transmission and/or playing. In various embodiments, the encoder 112 may publish, or otherwise make available, information on the available different resolutions, different bitrates, and/or different frame rates. For example, the encoder 112 may publish bitrates at which it may provide video or audio content to the content consumption device(s) 108. Encoding of audio data may be performed in accordance with, e.g., but are not limited to, the MP3 standard, promulgated by the Moving Picture Experts Group (MPEG). Encoding of video data may be performed in accordance with, e.g., but are not limited to, the H264 standard, promulgated by the International Telecommunication Unit (ITU) Video Coding Experts Group (VCEG). Encoder 112 may include one or more computing devices configured to perform content portioning, encoding, and/or transcoding, such as described herein.

Storage 114 may be temporal and/or persistent storage of any type, including, but are not limited to, volatile and non-volatile memory, optical, magnetic and/or solid state mass storage, and so forth. Volatile memory may include, but are not limited to, static and/or dynamic random access memory. Non-volatile memory may include, but are not limited to, electrically erasable programmable read-only memory, phase change memory, resistive memory, and so forth.

In various embodiments, content provisioning 116 may be configured to provide encoded content as discrete files and/or as continuous streams of encoded content. Content provisioning 116 may be configured to transmit the encoded audio/video data (and closed captions, if provided) in accordance with any one of a number of streaming and/or transmission protocols. The streaming protocols may include, but are not limited to, the Real-Time Streaming Protocol (RTSP). Transmission protocols may include, but are not limited to, the transmission control protocol (TCP), user datagram protocol (UDP), and so forth. Networks 106 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the content distribution end, networks 106 may include one or more local area networks with gateways and firewalls, through which content aggregator/distributor server 104 communicate with content consumption devices 108. Similarly, at the content consumption end, networks 106 may include base stations and/or access points, through which consumption devices 108 communicate with content aggregator/distributor server 104. In between the two ends may be any number of network routers, switches and other networking equipment of the like. However, for ease of understanding, these gateways, firewalls, routers, switches, base stations, access points and the like are not shown.

In various embodiments, as shown, a content consumption device 108 may include player 122, display 124 and user input device 126. Player 122 may be configured to receive streamed content, decode and recover the content from the content stream, and present the recovered content on display 124, in response to user selections/inputs from user input device 126.

In embodiments, player 122 may include decoder 132, presentation engine 134 and user interface engine 136. Decoder 132 may be configured to receive streamed content, decode and recover the content from the content stream. Presentation engine 134 may be configured to present the recovered content on display 124, in response to user selections/inputs. In embodiments, decoder 132 and/or presentation engine 134 may be configured to present audio and/or video content to a user that has been encoded using varying encoding control variable settings in a substantially seamless manner. Thus, in various embodiments, the decoder 132 and/or presentation engine 134 may be configured to present two portions of content that vary in resolution, frame rate, and/or compression settings without interrupting presentation of the content. User interface engine 136 may be configured to receive the user selections/inputs from a user, and to selectively render a menu interface as described herein.

While shown as part of a content consumption device 108, display 124 and/or user input device(s) 126 may be stand-alone devices or integrated, for different embodiments of content consumption devices 108. For example, and as depicted in FIGS. 2-7, for a television arrangement, display 124 may be a stand alone television set, Liquid Crystal Display (LCD), Plasma and the like, while player 122 may be part of a separate set-top set, and user input device 126 may be a separate remote control, gaming controller, keyboard, or another similar device. Similarly, for a desktop computer arrangement, player 122, display 124 and user input device(s) 126 may all be separate stand alone units. On the other hand, for a mobile arrangement, such as a tablet computing device, display 124 may be a touch sensitive display screen that includes user input device(s) 126, and player 122 may be a computing platform with a soft keyboard that also includes one of the user input device(s) 126. Further, display 124 and player 122 may be integrated within a single form factor. Similarly, for a smartphone arrangement, player 122, display 124 and user input device(s) 126 may be likewise integrated.

Referring now to FIG. 2, a player 122 in the form of a set-top box, or “console,” (configured with applicable portions of the present disclosure) may be operably coupled to a display 124, shown here in the form of a flat panel television. In FIG. 2, presentation engine 134 and/or user interface engine 136 of player 122 may render underlying media content 250 on display 124. In various embodiments, media content 250 may be provided to player 122 by content aggregator/distributor server 104. In various embodiments, media content 250 may come from one or more media content sources, such as the one or more providers of content 102 in FIG. 1.

Referring to FIG. 3, a menu interface 252 may be rendered, e.g., by user interface engine 136 of player 122, to overlay media content 250. In embodiments, menu interface 252 does not fully cover media content 250. At least a portion of media content remains visible while menu interface 252 is rendered. In various embodiments, menu interface 252 may include a first scrollable arrangement of selectable elements 254. In various embodiments, first scrollable arrangement of selectable elements 254 may be disposed along an axis, such as a vertical axis as is the case in FIG. 3, a horizontal axis, or an axis of any other orientation. In various embodiments, selectable elements of first scrollable arrangement of selectable elements 254 may represent sources of media content such as media content 250. In various embodiments, the sources of media content represented by selectable elements of first scrollable arrangement of selectable elements 254 may include any combination of broadcast channels, Internet channels, hybrid channels, application stores, satellite feeds, on-demand streaming video sources (video and music), and so forth. The sources of media content represented by selectable elements of first scrollable arrangement of selectable elements 254 need not include the source of media content 250 currently being presented.

A user may navigate through first scrollable arrangement of selectable elements 254, e.g., using user input device 126 (see FIG. 1) in order to select one of the media sources. This is seen in FIG. 3, where first scrollable arrangement of selectable elements 254 includes an active media source selectable element 256 and three inactive media source selectable elements 258. The selectable element that is currently active may be altered, e.g., in response to input received from user input device 126. In this manner, a viewer may “flip” through channels and other sources of media content. In various embodiments, selectable elements of first selectable arrangement of selectable elements 254 may resemble pictures, videos, corporate logos, and so forth.

In various embodiments, a selectable element may be rendered active by emphasizing it over other selectable elements, including but not limited to making it larger and/or more conspicuous than inactive selectable elements. Likewise, a selectable element may be rendered inactive by de-emphasizing it with respect to an active selectable element. For example, inactive selectable elements may be darkened or grayed out, and/or rendered smaller than an active selectable element.

To focus a viewer's attention on menu interface 252 while still enabling the viewer to at least partially consume underlying media content 250, in various embodiments, presentation engine 134 and/or user interface engine 136 of player 122 may cause underlying media content 250 to be rendered somewhat less conspicuously. For example, in FIG. 3, underlying media content 250 is blurred, so that a viewer may still at least partially consume media content 250 and also navigate menu interface 252.

Additionally or alternatively, presentation engine 134 and/or user interface engine 136 of player 122 may be configured to selectively obfuscate a portion 260 of underlying media content 250 overlaid by menu interface 252. For instance, player 122 may selectively gray out or darken pixels at portion 260 near first scrollable arrangement of selectable elements 254. An example of this is shown in FIG. 4, in which portion 260 of underlying media content 250 is gradually darkened, e.g., using a gradient, from right to left to draw attention to and/or avoid drawing attention from first scrollable arrangement of selectable elements 254.

Referring to FIG. 5, in various embodiments, on selection of a selectable element of first scrollable arrangement of selectable elements 254 by a viewer, e.g., using user input device 126, user interface engine 136 of player 122 may be configured to selectively render a second scrollable arrangement of selectable elements 262. In various embodiments, second scrollable arrangement of selectable elements 262 may represent media contents available from a selected one (e.g., represented by active media source selectable element 256) of the sources of media content represented by the selectable elements of first scrollable arrangement of selectable elements 254. In various embodiments, second scrollable arrangement of selectable elements 262 may be disposed along a second axis that extends laterally from the first axis. For example, in FIG. 5, second scrollable arrangement of selectable elements 262 extends perpendicularly from first scrollable arrangement of selectable elements 254, e.g., from active media source selectable element 256. In embodiments, unlike prior art grid or table listing type programming guides, second scrollable arrangement of selectable elements 262 is rendered only for the selected source. Scrollable arrangements of selectable elements representing media contents available from unselected sources are not provided at the same time. Similar to first scrollable arrangement of selectable elements 254, second scrollable arrangement of selectable elements 262 may be rendered overlaying underlying media content 250, but where possible, without fully covering the underlying media content.

As was the case with first scrollable arrangement of selectable elements 254, a viewer may navigate, e.g., using user input device 126, through second scrollable arrangement of selectable elements 262 in order to select one of the media contents. This is seen in FIG. 5, in which second scrollable list of selectable elements 262 includes an active selectable element 264 and three inactive selectable elements 266. The selectable element that is currently active may be altered, e.g., in response to input received from user input device 126. In various embodiments, the viewer may consume media content corresponding to active selectable element 264 by pressing a button or otherwise indicating the viewer's desire to consume the content.

In various embodiments, a selectable element of second scrollable arrangement of selectable elements 262 may be rendered active by emphasizing it over other selectable elements. This may include making it larger and/or more conspicuous than inactive selectable elements. Likewise, a selectable element may be rendered inactive by de-emphasizing it with respect to an active selectable element.

In various embodiments, selectable elements of second scrollable arrangement of selectable elements 262 may depict various graphics. For example, one or more selectable elements may include still images (e.g., screen shots, promotional images, etc.) and/or video clips (e.g., excerpts, trailers, etc.) of or associated with media content to which the one or more selectable elements correspond. For example, in some embodiments, active selectable element 264 may include a video clip while inactive selectable elements 266 may include still images. In other embodiments, all active and inactive selectable elements may include videos, but active selectable element 264 may be rendered, e.g., by user interface engine 136 of player 122, more largely and/or more conspicuously than inactive selectable elements 266. In some embodiments, user interface engine 136 and/or presentation engine 134 of player 122 may be configured to render sound associated with the video displayed in active selectable element 264, and may be configured to refrain from rendering sound associated with videos displayed in inactive selectable elements 266.

As was the case with first scrollable arrangement of selectable elements 254, presentation engine 134 and/or user interface engine 136 of player 122 may be configured to selectively obfuscate a portion 268 of underlying media content 250 overlaid by second scrollable arrangement of selectable elements 262. For instance, player 122 may selectively gray out or darken pixels at portion 268 near second scrollable arrangement of selectable elements 262. An example of this is shown in FIG. 6, in which portion 268 of the underlying media content 250 is gradually darkened from top to bottom, e.g., as a gradient, to draw attention to and/or avoid drawing attention from second scrollable arrangement of selectable elements 262.

In various embodiments, second scrollable arrangement of selectable elements 262 may include selectable elements that represent media contents available from the selected source (e.g., represented by active media source selectable element 256) of media content contemporaneously with rendering of menu interface 252 and/or rendering of second scrollable arrangement of selectable elements 262. For example, second scrollable arrangement of selectable elements 262 may include a selectable element that represents a program currently being broadcast by a source of media content. In some embodiments, this current content may be underlying media content 250. In some embodiments, when second arrangement of selectable elements 262 is rendered, e.g., in response to selection of one of the first scrollable arrangement of selectable elements 254, the selectable element of second scrollable arrangement of selectable elements 262 that represents the currently-broadcast program (e.g., 250) may be made active (e.g., 264) by default.

In various embodiments, second scrollable arrangement of selectable elements 262 may include, concurrently with the selectable element representing the current content, one or more selectable elements representing related on-demand media content. For example, if the current content is a particular film, selectable elements representing sequels or prequels to that film may be rendered as part of second scrollable arrangement of selectable elements 262, e.g., to the left or right (or above or below in other embodiments) of the selectable element that represents the current content.

In various embodiments, the on-demand media content represented by an selectable element in second scrollable arrangement of selectable elements 262 may be selected based on the current content (e.g., 250) in conjunction with various other information. In various embodiments, this other information may include popularity of the on-demand content, e.g., based on usage statistics. In various embodiments, the on-demand content may be selected by an entity (e.g., network) associated with the presently available media content. In various embodiments, the on-demand content may be associated with a similar genre (e.g., Holidays, Sports, Dancing, films by a particular director or with a particular star, etc.) as the presently available media content.

Additionally or alternatively, in various embodiments, the second scrollable arrangement of selectable elements 262 may include selectable elements that represent media contents made available from the selected source of media content (e.g., 256) previous to rendering of menu interface 252. For example, second scrollable arrangement of selectable elements 262 may include one or more selectable elements that represent programming previously broadcast by a source of media content, but are still available for deferred viewing on an on demand basis. The amount of previous broadcast or live streamed content that are still available for deferred viewing on an on demand basis may vary depending on a variety of factors, including but not limited to contractual agreements with media content sources (e.g., broadcasters, cable channels), computing resources of content aggregator/distributor server 104 (e.g., space on storage 114), and so forth. In various embodiments, previous content may be available from the past one, two, three, four, five, six, seven, or more days.

Additionally or alternatively, in various embodiments, second scrollable arrangement of selectable elements 262 may include selectable elements that represent media contents that will be made available from the selected source of media content (e.g., 256) at later date or time from rendering of menu interface 252. For example, second scrollable arrangement of selectable elements 262 may include one or more selectable elements that represent programming to be broadcast by a source of media content in the coming hours, days, weeks, and so forth.

Additionally or alternatively, in various embodiments, the second scrollable arrangement of selectable elements 262 may include selectable elements that represent multiple versions of a single media content. For example, one selectable element may represent a high-definition (HD) version of media content, and another selectable version may represent a standard definition version. As another example, one selectable element may represent a director's cut of media content, another selectable version may represent a theatrical cut, and/or another element may represented an “unrated” version.

Referring to FIGS. 5 and 6, in various embodiments, at least some of the selectable elements of second scrollable arrangement of selectable elements 262 may be rendered, e.g., by user interface engine 136 of player 122, as a group 270. In various embodiments, group 270 may have a size that is proportional to a temporal distance between the present media content and media contents corresponding to the selectable elements of the group. For example, group 270 may represent future programming on the selected media source, or future media contents related to the present media contents (e.g., future episodes). A group 270 containing selectable elements that represent future media contents available later in the same day may be smaller than, e.g., a group 270 containing selectable elements that represent media contents that will be available tomorrow, next week, next month, and so forth.

Similarly, in various embodiments, group 270 may be separated from a selectable element representing a present media content by a distance that is proportional to a temporal distance between the present media content and media contents corresponding to the selectable elements of the group. For example, a group 270 containing selectable elements that represent future media contents available later in the same day may be closer to a selectable element representing present content (e.g., underlying media content 250) than, e.g., a group 270 containing selectable elements that represent media contents that will be available tomorrow, next week, next month, and so forth.

In various embodiments, group 270 may have a size that is proportional to a relatedness between a present media content and media contents corresponding to the selectable elements of group 270. For example, a group 270 of selectable elements that represent other episodes in the same season as a selectable element representing current content (e.g., underlying media content 250) may be larger or smaller than another group 270 of selectable elements that represent episodes from a different season, or from a different but related show (e.g., spin-off, created by same entity, has common cast members, etc.).

In various embodiments, menu interface 252 may be customized based on preferences and/or history of one or more users. In some cases, preferences of a user may be established based on that user's history of use. For example, in various embodiments, first scrollable arrangement of selectable elements 254 may be rendered, e.g., by user interface engine 136 of player 122, in an order that may be based on relative frequency of use of corresponding sources of media content. Selectable elements representing often-used media sources may be bunched together and/or moved to a top or other navigational starting point of first scrollable arrangement of selectable elements 254. Likewise, selectable elements representing not-often-used media sources may be bunched together and/or moved to a bottom or other non-starting point of first scrollable arrangement of selectable elements 254.

In various embodiments, user preferences used, e.g., by user interface engine 136 of player 122, to customize menu interface 252 may be determined in various ways. Referring to FIG. 7, an example scenario is depicted in which a first user 770 and a second user 772 are simultaneously using player 122 to consume media content 250 on display 124. In various embodiments, menu interface 252 may be rendered in conformance with preferences associated with first user 770 and/or second user 772.

In various embodiments, player 122 may identify first user 770 and/or second user 772 using facial or other visual recognition. For instance, in various embodiments, an image capture device 774 may be coupled with player 122, and may be configured to provide captured image data to player 122, e.g., as input for facial recognition logic operating on player 122 or elsewhere. In various embodiments, including the one depicted in FIG. 7, image capture device 774 may be separate from player 122, and may take various forms, such as a camera and/or gaming controller configured to translate visually-observed motion from a user into commands operated upon by player 122. Additionally or alternatively, image capture device 774 may be integral with player 122.

In various embodiments, menu interface 252 may be rendered, e.g., by user interface engine 136 of player 122, in conformance with preferences associated with multiple users. For example, image capture device 774 and/or player 122 may determine that multiple users, e.g., first user 770 and second user 772, are able to concurrently consume media content 250. In such case, and assuming preferences for both users are available to player 122, user interface engine 136 of player 122 may render menu interface to conform, as best as possible, with preferences of both first user 770 and second user 772. For example, assume first user 770 prefers news, second user 772 prefers sports, and both are from Chicago. Player 122 may customize menu interface 252 to be more user-friendly to Chicagoans who like sports and sitcoms. For example, first scrollable arrangement of selectable elements 254 may bunch together, e.g., near a top or beginning of the arrangement, selectable elements representing sources of media content relating to Chicago, such as Chicago sports channels, Chicago-based broadcast channels that include news, and so forth.

User interface engine 136 of player 122 may customize menu interface 252 based on other information as well. For example, in some embodiments, user interface engine 136 of player 122 may customize menu interface 252 based on time of day. Continuing the above example, if the time of day is at time at which local news programs typically are aired, then player 122 may selectively arrange first scrollable arrangement of selectable elements 254 so that selectable elements representing media sources currently airing Chicago news are more likely to be at a location at which they are easily reached, e.g., near a navigational starting point. That way, first user 770 can readily find the content she wants. In contrast, at times of the day at which Chicago news is not being aired, player 122 may selectively arrange first scrollable arrangement of selectable elements 254 so that those same selectable elements are at a location where they are less-easily reached. For instance, those elements may be placed behind selectable elements representing other sources of media content that are providing content that is currently more relevant to first user 770 and/or second user 772.

FIG. 8 depicts an example process 800 that may be implemented by user interface engine 136 and/or presentation engine 134 of player 122, in accordance with various embodiments. At operation 802, a command to render menu interface 252 may be received, e.g., by player 122, from user input device 126. For instance, a viewer may press a “Menu” or other button on a remote control (e.g., 126), and the remote control may transmit a signal to player 122 that may cause user interface engine 136 to begin the process of rendering menu interface 252.

At operation 804, one or more viewers capable of consuming media content currently presented, e.g., by user interface engine 136 of player 122, may be identified. For example, player 122 may obtain image data from image capture device 774 of FIG. 7, and using facial recognition or other visual identification techniques, identify one or more viewers captured in the image data.

At operation 806, user preferences may be obtained for viewers identified at operation 804, e.g., by user interface engine 136 of player 122. User preferences may be obtained and/or inferred from data obtained from various sources, including but not limited to player 122 (which may track history of use), content aggregator/distributor server 104, one or more social networks (not shown), and so forth. At operation 808, other contextual information may be obtained, e.g., by player 122. Other contextual information may include data obtained from, or inferred from data obtained from, a global positioning system (GPS) unit on player 122 or elsewhere, a clock on player 122 or elsewhere, other sensors on player 122 or elsewhere, one or more social networks, and so forth.

Based on the user preferences obtained at operation 806 and/or contextual information obtained at operation 808, at operation 810, first scrollable arrangement of selectable elements 254 may be selectively rendered, e.g., by player 122. At operation 812, a portion (e.g., 260) of underlying media content 250 may be selectively obfuscated, e.g., by user interface engine 136 and/or presentation engine 134 of player 122, to draw attention to, or to avoid drawing attention from, first scrollable arrangement of selectable elements 254.

At operation 814, a selection of an element of first scrollable arrangement of selectable elements 254, e.g., active selectable element 256, may be received at player 122. For example, while a particular selectable element of first scrollable arrangement of selectable elements 254 is active, the user may hit a particular button (e.g., “Enter) on a remote control (e.g., user input device 126) or otherwise indicate that the user wishes to view content from that particular source of media content (e.g., by making a gesture that is captured by image capture device 774).

At operation 816, based on the user preferences obtained at operation 806, contextual information obtained at operation 808 and/or the user's selection at operation 814 of a selectable element in first scrollable arrangement of selectable elements 254, at operation 816, second scrollable arrangement of selectable elements 262 may be selectively rendered, e.g., by user interface engine 136 of player 122. At operation 818, a portion (e.g., 268) of underlying media content 250 may be selectively obfuscated, e.g., by user interface engine 136 and/or presentation engine 134 of player 122, to draw attention to, or to avoid drawing attention from, second scrollable arrangement of selectable elements 262.

Referring now to FIG. 9, an example computer suitable for use for various components of FIG. 1, such as content consumption device 108, is illustrated in accordance with various embodiments. But, before describing computer 900 in more detail, it should be noted, while for ease of understanding, the menu interface has been described with a first scrollable arrangement of selectable elements representing sources of media content, disposed on one axis, and a second scrollable arrangement of selectable elements representing media contents of a selected source, overlaying but not fully obstructing underlying media content, the present disclosure is not so limited. The present disclosure may be practiced, e.g., by allowing more than one source on the first axis to be selected, and scrollable arrangements of selectable elements representing media contents available from the more than one selected sources may be provided, in the overlaying but not fully obstructing manner. As shown, computer 900 may include one or more processors or processor cores 902, and system memory 904. For the purpose of this application, including the claims, the terms “processor” and “processor cores” may be considered synonymous, unless the context clearly requires otherwise. Additionally, computer 900 may include mass storage devices 906 (such as diskette, hard drive, compact disc read only memory (CD-ROM) and so forth), input/output devices 908 (such as display, keyboard, cursor control, remote control, gaming controller, image capture device, and so forth) and communication interfaces 910 (such as network interface cards, modems, infrared receivers, radio receivers (e.g., Bluetooth), and so forth). The elements may be coupled to each other via system bus 912, which may represent one or more buses. In the case of multiple buses, they may be bridged by one or more bus bridges (not shown).

Each of these elements may perform its conventional functions known in the art. In particular, system memory 904 and mass storage devices 906 may be employed to store a working copy and a permanent copy of the programming instructions implementing the operations associated with content consumption device 108, e.g., operations shown in FIG. 8. The various elements may be implemented by assembler instructions supported by processor(s) 902 or high-level languages, such as, for example, C, that can be compiled into such instructions.

The permanent copy of the programming instructions may be placed into permanent storage devices 906 in the factory, or in the field, through, for example, a distribution medium (not shown), such as a compact disc (CD), or through communication interface 910 (from a distribution server (not shown)). That is, one or more distribution media having an implementation of the agent program may be employed to distribute the agent and program various computing devices.

The number, capability and/or capacity of these elements 910-912 may vary, depending on whether computer 900 is used as a content aggregator/distributor server 104 or a content consumption device 108 (e.g., a player 122), as well as whether computer 900 is a stationary computing device, such as a set-top box or desktop computer, or a mobile computing device such as a tablet computing device, laptop computer or smartphone. Their constitutions are otherwise known, and accordingly will not be further described.

FIG. 10 illustrates an example non-transitory computer-readable storage medium 1002 having instructions configured to practice all or selected ones of the operations associated with content aggregator/distributor servers 104 or content consumption devices 108, earlier described, in accordance with various embodiments. As illustrated, non-transitory computer-readable storage medium 1002 may include a number of programming instructions 1004. Programming instructions 1004 may be configured to enable a device, e.g., computer 900, in response to execution of the programming instructions, to perform, e.g., various operations of process 800 of FIG. 8, e.g., but not limited to, to the various operations performed to selectively render menu interface 252. In alternate embodiments, programming instructions 1004 may be disposed on multiple non-transitory computer-readable storage media 1002 instead.

Referring back to FIG. 9, for one embodiment, at least one of processors 902 may be packaged together with computational logic 922 configured to practice aspects of process 800 of FIG. 8. For one embodiment, at least one of processors 902 may be packaged together with computational logic 922 configured to practice aspects of process 800 of FIG. 8 to form a System in Package (SiP). For one embodiment, at least one of processors 902 may be integrated on the same die with computational logic 922 configured to practice aspects of process 800 of FIG. 8. For one embodiment, at least one of processors 902 may be packaged together with computational logic 922 configured to practice aspects of process 800 of FIG. 8 to form a System on Chip (SoC). For at least one embodiment, the SoC may be utilized in, e.g., but not limited to, a mobile computing device such as a computing tablet or smartphone.

The following paragraphs describe examples of various embodiments.

### EXAMPLES

Example 1 is direct to at least one computer-readable medium comprising instructions that, in response to execution of the instructions by a computing device, enable the computing device to selectively render a menu interface, wherein selectively render the menu interface comprises: selectively render a first scrollable arrangement of selectable elements disposed along a first axis to represent sources of media content; and selectively render a second scrollable arrangement of selectable elements to represent only media contents available from a selected one of the sources of media content, and not unselected ones of the sources of media content, wherein the second scrollable arrangement of selectable elements is disposed along a second axis that extends laterally from the first axis.

Example 2 includes the at least one computer-readable medium of Example 1, wherein selectively render the menu interface further comprises selectively render the menu interface to overlay underlying media content, provided by a source of media content, that is actively presented on a display, wherein at least a portion of the underlying media content remains visible.

Example 3 includes the at least one computer-readable medium of Example 2, wherein selectively render the menu interface further comprises blur the underlying media content while the menu interface is rendered.

Example 4 includes the at least one computer-readable medium of Example 2, wherein selectively render the menu interface further comprises selectively obfuscate a portion of the underlying media content overlaid by the menu interface.

Example 5 includes the at least one computer-readable medium of Example 4, wherein selectively obfuscate comprises gray out or darken pixels.

Example 6 includes the at least one computer-readable medium of any one of Examples 1-5, wherein selectively render the second scrollable arrangement comprises selectively render the second scrollable arrangement in response to selection of an element of the first scrollable arrangement that represents the selected one of the sources of media content.

Example 7 includes the at least one computer-readable medium of any one of Examples 1-5, wherein selectively render the second scrollable arrangement of selectable elements comprises selectively render selectable elements that represent media contents available from the selected source of media content contemporaneously with the render of the menu interface.

Example 8 includes the at least one computer-readable medium of Example 7, wherein selectively render the second scrollable arrangement of selectable elements further comprises selectively render selectable elements that represent media contents made available from the selected source of media content previous to the render of the menu interface.

Example 9 includes the at least one computer-readable medium of Example 7, wherein selectively render the second scrollable arrangement of selectable elements further comprises selectively render selectable elements that represent media contents that will be made available from the selected source of media content at later date or time from the render of the menu interface.

Example 10 includes the at least one computer-readable medium of Example 7, wherein selectively render the second scrollable arrangement of selectable elements further comprises selectively render at least some of the selectable elements of the second scrollable arrangement as a group having a size that is proportional to, or that is separated from a selectable element that represents a present media content by a distance that is proportional to, a temporal distance between the present media content and media contents corresponding to the selectable elements of the group.

Example 11 includes the at least one computer-readable medium of any one of Examples 1-5, wherein selectively render the second scrollable arrangement of selectable elements further comprises selectively render at least some of the selectable elements of the second scrollable arrangement as a group having a size that is proportional to a relatedness between a present media content and media contents that correspond to the selectable elements of the group.

Example 12 includes the at least one computer-readable medium of any one of Examples 1-5, wherein the sources of media content comprise two or more of a broadcast channel, an Internet channel, a hybrid channel, an application store, and an on-demand streaming video source.

Example 13 includes the at least one computer-readable medium of any one of Examples 1-5, wherein selectively render the first scrollable arrangement comprises selectively render elements of the first scrollable arrangement in an order based on relative frequency of use of corresponding sources of media content.

Example 14 includes the at least one computer-readable medium of any one of Examples 1-5, wherein selectively render the menu interface further comprises render the first and second scrollable arrangements in conformance with preferences associated with a particular user, based on facial recognition of the particular user.

Example 15 includes the at least one computer-readable medium of any one of Examples 1-5, wherein selectively render the menu interface further comprises render the first and second scrollable arrangements in conformance with preferences associated with multiple users, based on a determination that the multiple users are able to concurrently consume the media content.

Example 16 includes the at least one computer-readable medium of any one of Examples 1-5, wherein selectively render the second scrollable arrangement of selectable elements further comprises selectively render the second scrollable arrangement of selectable elements to represent media content available on the selected source of media content contemporaneously with the render of the menu interface and at least one related on-demand media content.

Example 17 includes the at least one computer-readable medium of Example 16, wherein the at least one related on-demand media content comprises media content that is determined to be popular based on usage statistics, selected by an entity associated with the presently available media content, or associated with a similar genre as the presently available media content.

Example 18 is directed to an apparatus comprising: one or more processors; memory coupled with the one or more processors; and a user interface engine coupled with the one or more processors and configured to: selectively render a first scrollable arrangement of selectable elements disposed along a first axis to represent sources of media content; and in response to selection of an element of the first scrollable arrangement that represents one of the sources of media content, selectively render a second scrollable arrangement of selectable elements to represent media contents available from the selected one of the sources of media content, wherein the second scrollable arrangement of selectable elements is disposed along a second axis that extends laterally from the first axis. The first and second scrollable arrangements of selectable elements are to overlay underlying media content, provided by a source of media content, that is actively presented on the display, wherein at least a portion of the underlying media content remains visible

Example 19 includes the apparatus of Example 18, wherein the user interface engine is further configured to selectively render the second scrollable arrangement of selectable elements for the selected one of the sources of media, without rendering scrollable arrangements of selectable elements representing media contents available from unselected ones of the sources of media content

Example 20 includes the apparatus of Example 19, wherein the user interface engine is further configured to selectively obfuscate a portion of the underlying media content overlaid by the first and second scrollable arrangements of selectable elements.

Example 21 includes the apparatus of Example 18, wherein the user interface engine is further configured to selectively render selectable elements that represent media contents available from the selected source of media content contemporaneously with the render of the first and second scrollable arrangements of selectable elements.

Example 22 includes the apparatus of Example 21, wherein the user interface engine is further configured to: selectively render selectable elements in the second scrollable arrangement that represent media contents made available from the selected source of media content previous to the render of the menu interface; and selectively render selectable elements in the second scrollable arrangement that represent media contents that will be made available from the selected source of media content at later date or time from the render of the menu interface.

Example 23 includes the apparatus of any one of Examples 18-22, wherein the sources of media content comprise two or more of a broadcast channel, an Internet channel, a hybrid channel, an application store, and an on-demand streaming video source.

Example 24 includes the apparatus of any one of Examples 18-22, wherein selectively render the first scrollable arrangement comprises selectively render elements of the first scrollable arrangement in an order based on relative frequency of use of corresponding sources of media content.

Example 25 includes the apparatus of any one of Examples 18-22, wherein the user interface engine is further configured to render the first and second scrollable arrangements in conformance with preferences associated with a particular user, based on facial recognition of the particular user.

Example 26 includes the apparatus of any one of Examples 18-22, wherein the user interface engine is further configured to render the first and second scrollable arrangements in conformance with preferences associated with multiple users, based on a determination that the multiple users are able to concurrently consume the media content.

Example 27 includes the apparatus of any one of Examples 18-22, wherein selectively render the second scrollable arrangement of selectable elements further comprises selectively render the second scrollable arrangement of selectable elements to represent media content available on the selected source of media content contemporaneously with the render of the menu interface and at least one related on-demand media content.

Example 28 is directed to a computer-implemented method, comprising: selectively rendering, by a computing device on a display, a first scrollable arrangement of selectable elements disposed along a first axis to represent sources of media content; and selectively rendering, by the computing device, a second scrollable arrangement of selectable elements to represent media contents available from a selected one of the sources of media content, wherein the second scrollable arrangement of selectable elements is disposed along a second axis that extends laterally from the first axis. The selectively rendering the second scrollable arrangement of selectable elements further comprises selectively rendering selectable elements that represent media contents made available from the selected source of media content previous to the selective rendering of the second scrollable arrangement of selectable elements.

Example 29 includes the computer-implemented method of Example 28, further comprising selectively rendering, by the computing device, the first and second scrollable arrangements of selectable elements to overlay underlying media content, provided by one of the sources of media content, that is actively presented on the display.

Example 30 includes the computer-implemented method of Example 29, further comprising blurring, by the computing device, the underlying media content.

Example 31 includes the computer-implemented method of Example 29, further comprising selectively obfuscating, by the computing device, a portion of the underlying media content overlaid by the first or second scrollable arrangement of selectable elements.

Example 32 includes the computer-implemented method of Example 31, wherein selectively obfuscating comprises graying out or darkening pixels.

Example 33 includes the computer-implemented method of any one of Examples 28-32, further comprising selectively rendering, by the computing device, the second scrollable arrangement in response to selection of an element of the first scrollable arrangement that represents the selected one of the sources of media content.

Example 34 includes the computer-implemented method of any one of Examples 28-32, wherein selectively rendering the second scrollable arrangement of selectable elements comprises selectively rendering selectable elements that represent media contents available from the selected source of media content contemporaneously with the selective rendering of the second scrollable arrangement of selectable elements.

Example 35 includes the computer-implemented method of Example 28, wherein the second scrollable arrangement of selectable elements is rendered to represent only media contents available from the selected one of the sources of media content, and not unselected sources of media content.

Example 36 includes the computer-implemented method of Example 34, wherein selectively rendering the second scrollable arrangement of selectable elements further comprises selectively rendering selectable elements that represent media contents that will be made available from the selected source of media content at later date or time from the selective rendering of the second scrollable arrangement of selectable elements.

Example 37 includes the computer-implemented method of Example 34, wherein selectively rendering the second scrollable arrangement of selectable elements further comprises selectively rendering at least some of the selectable elements of the second scrollable arrangement as a group having a size that is proportional to, or that is separated from a selectable element that represents a present media content by a distance that is proportional to, a temporal distance between the present media content and media contents corresponding to the selectable elements of the group.

Example 38 includes the computer-implemented method of any one of Examples 28-32, wherein selectively rendering the second scrollable arrangement of selectable elements further comprises selectively rendering at least some of the selectable elements of the second scrollable arrangement as a group having a size that is proportional to a relatedness between a present media content and media contents that correspond to the selectable elements of the group.

Example 39 includes the computer-implemented method of any one of Examples 28-32, wherein the sources of media content comprise two or more of a broadcast channel, an Internet channel, a hybrid channel, an application store, and an on-demand streaming video source.

Example 40 includes the computer-implemented method of any one of Examples 28-32, wherein selectively rendering the first scrollable arrangement comprises selectively rendering elements of the first scrollable arrangement in an order based on relative frequency of use of corresponding sources of media content.

Example 41 includes the computer-implemented method of any one of Examples 28-32, further comprising rendering, by the computing device, the first and second scrollable arrangements in conformance with preferences associated with a particular user, based on facial recognition of the particular user.

Example 42 includes the computer-implemented method of any one of Examples 28-32, further comprising rendering the first and second scrollable arrangements in conformance with preferences associated with multiple users, based on a determination that the multiple users are able to concurrently consume the media content.

Example 43 includes the computer-implemented method of any one of Examples 28-32, further comprising selectively rendering, by the computing device, the second scrollable arrangement of selectable elements to represent media content available on the selected source of media content contemporaneously with the rendering of the second scrollable arrangement of selectable elements, and at least one related on-demand media content.

Example 44 includes the computer-implemented method of Example 43, wherein the at least one related on-demand media content comprises media content that is determined to be popular based on usage statistics, selected by an entity associated with the presently available media content, or associated with a similar genre as the presently available media content.

Example 45 is directed to an apparatus, comprising: means for selectively rendering, on a display, a first scrollable arrangement of selectable elements disposed along a first axis to represent sources of media content; and means for selectively rendering a second scrollable arrangement of selectable elements to represent media contents available from a selected one of the sources of media content, wherein the second scrollable arrangement of selectable elements is disposed along a second axis that extends laterally from the first axis.

Example 46 includes the apparatus of Example 45, further comprising means for selectively rendering the first and second scrollable arrangements of selectable elements to overlay underlying media content, provided by one of the sources of media content, that is actively presented on the display.

Example 47 includes the apparatus of Example 46, further comprising means for blurring the underlying media content.

Example 48 includes the apparatus of Example 46, further comprising means for selectively obfuscating a portion of the underlying media content overlaid by the first or second scrollable arrangement of selectable elements.

Example 49 includes the apparatus of Example 48, wherein the means for selectively obfuscating comprise means for graying out or darkening pixels.

Example 50 includes the apparatus of any one of Examples 45-49, further comprising means for selectively rendering the second scrollable arrangement in response to selection of an element of the first scrollable arrangement that represents the selected one of the sources of media content.

Example 51 includes the apparatus of any one of Examples 45-49, wherein the means for selectively rendering the second scrollable arrangement of selectable elements comprises means for selectively rendering selectable elements that represent media contents available from the selected source of media content contemporaneously with the selective rendering of the second scrollable arrangement of selectable elements.

Example 52 includes the apparatus of Example 51, wherein the means for selectively rendering the second scrollable arrangement of selectable elements further comprises means for selectively rendering selectable elements that represent media contents made available from the selected source of media content previous to the selective rendering of the second scrollable arrangement of selectable elements.

Example 53 includes the apparatus of Example 51, wherein the means for selectively rendering the second scrollable arrangement of selectable elements further comprises means for selectively rendering selectable elements that represent media contents that will be made available from the selected source of media content at later date or time from the selective rendering of the second scrollable arrangement of selectable elements.

Example 54 includes the apparatus of Example 51, wherein the means for selectively rendering the second scrollable arrangement of selectable elements further comprises means for selectively rendering at least some of the selectable elements of the second scrollable arrangement as a group having a size that is proportional to, or that is separated from a selectable element that represents a present media content by a distance that is proportional to, a temporal distance between the present media content and media contents corresponding to the selectable elements of the group.

Example 55 includes the apparatus of any one of Examples 45-49, wherein the means for selectively rendering the second scrollable arrangement of selectable elements further comprises means for selectively rendering at least some of the selectable elements of the second scrollable arrangement as a group having a size that is proportional to a relatedness between a present media content and media contents that correspond to the selectable elements of the group.

Example 56 includes the apparatus of any one of Examples 45-49, wherein the sources of media content comprise two or more of a broadcast channel, an Internet channel, a hybrid channel, an application store, and an on-demand streaming video source.

Example 57 includes the apparatus of any one of Examples 45-49, wherein the means for selectively rendering the first scrollable arrangement comprises means for selectively rendering elements of the first scrollable arrangement in an order based on relative frequency of use of corresponding sources of media content.

Example 58 includes the apparatus of any one of Examples 45-49, further comprising means for rendering the first and second scrollable arrangements in conformance with preferences associated with a particular user, based on facial recognition of the particular user.

Example 59 includes the apparatus of any one of Examples 45-49, further comprising means for rendering the first and second scrollable arrangements in conformance with preferences associated with multiple users, based on a determination that the multiple users are able to concurrently consume the media content.

Example 60 includes the apparatus of any one of Examples 45-49, further comprising means for selectively rendering the second scrollable arrangement of selectable elements to represent media content available on the selected source of media content contemporaneously with the rendering of the second scrollable arrangement of selectable elements, and at least one related on-demand media content.

Example 61 includes the apparatus of Example 60, wherein the at least one related on-demand media content comprises media content that is determined to be popular based on usage statistics, selected by an entity associated with the presently available media content, or associated with a similar genre as the presently available media content.

Computer-readable media (including non-transitory computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A non-transitory computer-readable medium comprising instructions that, in response to execution of the instructions by a computing device, enable the computing device to selectively render a menu interface, wherein selectively render the menu interface comprises:
selectively render a first scrollable arrangement of selectable elements disposed along a first axis to represent sources of media content; and
selectively render a second scrollable arrangement of selectable elements to represent only media contents available from a selected one of the sources of media content, and not unselected ones of the sources of media content, wherein the second scrollable arrangement of selectable elements is disposed along a second axis that extends from the first axis.

2. The non-transitory computer-readable medium of claim 1, wherein selectively render the menu interface further comprises selectively render the menu interface to overlay underlying media content, provided by a source of media content, that is actively presented on a display, wherein at least a portion of the underlying media content remains visible.

3. The non-transitory computer-readable medium of claim 2, wherein selectively render the menu interface further comprises blur the underlying media content while the menu interface is rendered.

4. The non-transitory computer-readable medium of claim 2, wherein selectively render the menu interface further comprises selectively obfuscate a portion of the underlying media content overlaid by the menu interface.

5. The non-transitory computer-readable medium of claim 4, wherein selectively obfuscate comprises gray out or darken pixels.

6. The non-transitory computer-readable medium of claim 1, wherein selectively render the second scrollable arrangement comprises selectively render the second scrollable arrangement in response to selection of an element of the first scrollable arrangement that represents the selected one of the sources of media content.

7. The non-transitory computer-readable medium of claim 1, wherein selectively render the second scrollable arrangement of selectable elements comprises selectively render selectable elements that represent media contents available from the selected source of media content contemporaneously with the render of the menu interface.

8. The non-transitory computer-readable medium of claim 7, wherein selectively render the second scrollable arrangement of selectable elements further comprises selectively render selectable elements that represent media contents made available from the selected source of media content previous to the render of the menu interface.

9. The non-transitory computer-readable medium of claim 7, wherein selectively render the second scrollable arrangement of selectable elements further comprises selectively render selectable elements that represent media contents that will be made available from the selected source of media content at later date or time from the render of the menu interface.

10. The non-transitory computer-readable medium of claim 7, wherein selectively render the second scrollable arrangement of selectable elements further comprises selectively render at least some of the selectable elements of the second scrollable arrangement as a group having a size that is proportional to, or that is separated from a selectable element that represents a present media content by a distance that is proportional to, a temporal distance between the present media content and media contents corresponding to the selectable elements of the group.

11. The non-transitory computer-readable medium of claim 1, wherein selectively render the second scrollable arrangement of selectable elements further comprises selectively render at least some of the selectable elements of the second scrollable arrangement as a group having a size that is proportional to a relatedness between a present media content and media contents that corresponds to the selectable elements of the group.

12. The non-transitory computer-readable medium of claim 1, wherein the sources of media content comprise two or more of a broadcast channel, an Internet channel, a hybrid channel, an application store, and an on-demand streaming video source.

13. The non-transitory computer-readable medium of claim 1, wherein selectively render the first scrollable arrangement comprises selectively render elements of the first scrollable arrangement in an order based on relative frequency of use of corresponding sources of media content.

14. The non-transitory computer-readable medium of claim 1, wherein selectively render the menu interface further comprises render the first and second scrollable arrangements in conformance with preferences associated with a particular user.

15. The non-transitory computer-readable medium of claim 1, wherein selectively render the menu interface further comprises render the first and second scrollable arrangements in conformance with preferences associated with multiple users, based on a determination that the multiple users are able to concurrently consume the media content.

16. The non-transitory computer-readable medium of claim 1, wherein selectively render the second scrollable arrangement of selectable elements further comprises selectively render the second scrollable arrangement of selectable elements to represent media content available on the selected source of media content contemporaneously with the render of the menu interface and at least one related on-demand media content.

17. The non-transitory computer-readable medium of claim 16, wherein the at least one related on-demand media content comprises media content that is determined to be popular based on usage statistics, selected by an entity associated with the presently available media content, or associated with a similar genre as the presently available media content.

18. An apparatus comprising:
one or more processors;
memory coupled with the one or more processors; and
a user interface engine coupled with the one or more processors and configured to:
selectively render a first scrollable arrangement of selectable elements disposed along a first axis to represent sources of media content; and
in response to selection of an element of the first scrollable arrangement that represents one of the sources of media content, selectively render a second scrollable arrangement of selectable elements to represent media contents available from the selected one of the sources of media content, wherein the second scrollable arrangement of selectable elements is disposed along a second axis that extends from the first axis;
wherein the user interface engine is further configured to selectively render the first and second scrollable arrangements of selectable elements to overlay underlying media content, provided by a source of media content, wherein at least a portion of the underlying media content remains visible.

19. The apparatus of claim 18, wherein the user interface engine is further configured to selectively render the second scrollable arrangement of selectable elements for the selected one of the sources of media, without rendering scrollable arrangements of selectable elements representing media contents available from unselected ones of the sources of media content.

20. The apparatus of claim 18, wherein the user interface engine is further configured to selectively obfuscate a portion of the underlying media content overlaid by the first and second scrollable arrangements of selectable elements.

21. The apparatus of claim 18, wherein the user interface engine is further configured to selectively render selectable elements that represent media contents available from the selected source of media content contemporaneously with the render of the first and second scrollable arrangements of selectable elements.

22. The apparatus of claim 21, wherein the user interface engine is further configured to:
selectively render selectable elements in the second scrollable arrangement that represent media contents made available from the selected source of media content previous to the render of the menu interface; and
selectively render selectable elements in the second scrollable arrangement that represent media contents that will be made available from the selected source of media content at later date or time from the render of the menu interface.

23. A computer-implemented method comprising:
selectively rendering, by a computing device on a display to overlay media content presented on the display, a first scrollable arrangement of selectable elements disposed along a first axis and representing sources of media content; and
in response to selection of an element of the first scrollable arrangement that represents one of the sources of media content, selectively rendering, by the computing device on the display to overlay the presented media content, a second scrollable arrangement of selectable elements representing media contents available from a selected one of the sources of media content, wherein the second scrollable arrangement of selectable elements is disposed along a second axis that extends from the first axis;
wherein selectively render the second scrollable arrangement of selectable elements further comprises selectively render selectable elements that represent media contents made available from the selected source of media content previous to the render of the menu interface.

24. The computer-implemented method of claim 23, further comprising selectively obfuscating, by the computing device, a portion of the underlying media content overlaid by the first and second scrollable arrangements of selectable elements.

25. The computer-implemented method of claim 23, wherein selectively rendering the second scrollable arrangement of selectable elements comprises selectively rendering, by the computing device, the second scrollable arrangement of selectable elements to represent media content available on the selected source of media content contemporaneously with rendering of the menu interface and at least one related on-demand media content.
